(19) United States
(12) Patent Application Publication
(10) Pub. No.: US 2022/0223850 A1
(43) Pub. Date: Jul. 14, 2022

(54) NEGATIVE ELECTRODE, ELECTROCHEMICAL DEVICE CONTAINING SAME, AND ELECTRONIC DEVICE

(71) Applicant: Ningde Amperex Technology Limited, Ningde, (CN)

(72) Inventors: Zhihuan CHEN, Ningde (CN); Daoyi JIANG, Ningde (CN); Hang CUI, Ningde (CN); Yuansen XIE, Ningde (CN)

(73) Assignee: Ningde Amperex Technology Limited, Ningde (CN)

(21) Appl. No.: 17/707,059

(22) Filed: Mar. 29, 2022

Related U.S. Application Data
(63) Continuation of application No. PCT/CN2019/128830, filed on Dec. 26, 2019.

(51) Int. Cl. H01M 4/38; H01M 4/04; H01M 4/583; H01M 10/0525

(52) U.S. Cl. CPC H01M 4/386; H01M 4/0404; H01M 2004/027; H01M 10/0525; H01M 4/583

(57) ABSTRACT

A negative electrode includes a current collector and a coating located on the current collector. The coating includes silicon-based particles and graphite particles. The silicon-based particles include a silicon-containing substrate and a polymer layer. The polymer layer includes a polymer and carbon nanotubes. The polymer layer is located on at least a part of a surface of the silicon-containing substrate. A minimum value of film resistances at different positions on a surface of the coating is R1, a maximum value of the film resistances is R2, an R1/R2 ratio is M, and a percentage of a weight of the silicon-based particles in a total weight of the silicon-based particles and the graphite particles is N, where M≥0.5, and N is 2 wt %-80 wt %.

### CROSS-REFERENCE TO RELATED APPLICATIONS

This application is a continuation of PCT application PCT/CN2019/128830, filed on Dec. 26, 2019, the disclosure of which is hereby incorporated by reference in its entirety.

### TECHNICAL FIELD

This application relates to the field of energy storage, and in particular, to a negative electrode, an electrochemical device containing same, and an electronic device, especially a lithium-ion battery.

### BACKGROUND

With popularization of consumer electronics products such as a notebook computer, a mobile phone, a tablet computer, a mobile power supply, and an unmanned aerial vehicle, requirements on an electrochemical device contained in such products are increasingly higher. For example, a battery not only needs to be light, but also needs to have a high capacity and a long service life. Lithium-ion batteries have occupied the mainstream position in the market by virtue of their superior advantages such as a high energy density, high safety, no memory effect, and a long service life.

### SUMMARY

Embodiments of this application provide a negative electrode in an attempt to solve at least one problem in the related art to at least some extent. The embodiments of this application further provide an electrochemical device that uses the negative electrode, and an electronic device.

In an embodiment, this application provides a negative electrode. The negative electrode includes a current collector and a coating located on the current collector. The coating includes silicon-based particles and graphite particles. The silicon-based particles include a silicon-containing substrate and a polymer layer. The polymer layer includes a polymer and carbon nanotubes. The polymer layer is located on at least a part of a surface of the silicon-containing substrate. A minimum value of film resistances at different positions on a surface of the coating is R1, a maximum value of the film resistances is R2, an R1/R2 ratio is M, and a percentage of a weight of the silicon-based particles in a total weight of the silicon-based particles and the graphite particles is N, where M≥approximately 0.5, and N is approximately 2 wt %˜80 wt %.

In another embodiment, this application provides an electrochemical device, including the negative electrode according to the embodiment of this application.

In another embodiment, this application provides an electronic device, including the electrochemical device according to the embodiment of this application.

The lithium-ion battery prepared by using the negative electrode according to this application achieves higher cycle performance, higher rate performance, a higher strain-resistant capability, and a lower direct-current resistance.

Additional aspects and advantages of the embodiments of this application will be described and illustrated in part later herein or expounded through implementation of the embodiments of this application.

### BRIEF DESCRIPTION OF DRAWINGS

For ease of describing the embodiments of this application, the following outlines the drawings necessary for describing the embodiments of this application or the prior art. Apparently, the drawings outlined below are merely a part of embodiments in this application. Without making any creative efforts, a person skilled in the art can still obtain the drawings of other embodiments according to the structures illustrated in these drawings.

FIG. 1 is a schematic structural diagram of a silicon-based negative active material according to an embodiment of this application;

FIG. 2 shows a scanning electron microscope (SEM) image of a surface of an SiO particle;

FIG. 3 shows an SEM image of a surface of a silicon-based negative active material according to Embodiment 2 of this application;

FIG. 4 shows an SEM image of a cross section of a negative electrode according to Embodiment 2 of this application;

FIG. 5 shows an SEM image of a cross section of a negative electrode according to Embodiment 8 of this application;

FIG. 6 shows an SEM image of a cross section of a negative electrode according to Embodiment 9 of this application;

FIG. 7 shows an SEM image of a cross section of a negative electrode according to Comparative Embodiment 1 of this application.

### DETAILED DESCRIPTION

Embodiments of this application will be described in detail below. The embodiments of this application shall not be construed as a limitation on this application.

The term “approximately” used this application is intended to describe and represent small variations. When used with reference to an event or situation, the terms may denote an example in which the event or situation occurs exactly and an example in which the event or situation occurs very approximately. For example, when used together with a numerical value, the term may represent a variation range falling within ±10% of the numerical value, such as ±5%, ±4%, ±3%, ±2%, ±1%, ±0.5%, ±0.1%, or ±0.05% of the numerical value.

In this application, Dv50 represents a particle size of the silicon-based negative active material at a cumulative volume of 50%, as measured in μm.

In this application, Dn10 represents a particle size of the silicon-based negative active material at a cumulative quantity of 10%, as measured in pm.

In addition, a quantity, a ratio, or another numerical value is sometimes expressed in a range format herein. Understandably, such a range format is for convenience and brevity, and shall be flexibly understood to include not only the numerical values explicitly specified and defined in the range, but also all individual numerical values or sub-ranges covered in the range as if each individual numerical value and each sub-range were explicitly specified.

In the description of specific embodiments and claims, a list of items referred to by using the terms such as “one of”, “one thereof”, “one type of” or other similar terms may mean any one of the listed items. For example, if items A and B are listed, the phrase “one of A and B” means A alone, or B alone. In another example, if items A, B, and C are listed, then the phrases “one of A, B, and C” and “one of A, B, or C” mean: A alone; B alone; or C alone. The item A may include a single component or a plurality of components. The item B may include a single component or a plurality of components. The item C may include a single component or a plurality of components.

In the description of embodiments and claims, a list of items referred to by using the terms such as “at least one of”, “at least one thereof”, “at least one type of” or other similar terms may mean any combination of the listed items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

I. Negative Electrode

In some embodiments, this application provides a negative electrode. The negative electrode includes a current collector and a coating located on the current collector. The coating includes silicon-based particles and graphite particles. The silicon-based particles include a silicon-containing substrate and a polymer layer. The polymer layer includes a polymer and carbon nanotubes. The polymer layer is located on at least a part of a surface of the silicon-containing substrate. A minimum value of film resistances at different positions on a surface of the coating is R1, a maximum value of the film resistances is R2, an R1/R2 ratio is M, and a percentage of a weight of the silicon-based particles in a total weight of the silicon-based particles and the graphite particles is N, where M≥approximately 0.5. In other embodiments, the polymer layer is located on an entire surface of the silicon-containing substrate.

In some embodiments, a minimum value R1 of R is approximately 5˜500 mΩ. In some embodiments, the minimum value R1 of R is approximately 5 mΩ, approximately 10 mΩ, approximately 20 mΩ, approximately 30 mΩ, approximately 40 mΩ, approximately 50 mΩ, approximately 100 mΩ, approximately 150 mΩ, approximately 200 mΩ, approximately 250 mΩ, approximately 300 mΩ, approximately 400 mΩ, approximately 450 mΩ, approximately 500 mΩ, or a range formed by any two of such values.

In some embodiments, a maximum value R2 of R is approximately 5˜800 mΩ. In some embodiments, the maximum value R2 of R is approximately 5 mΩ, approximately 10 mΩ, approximately 20 mΩ, approximately 30 mΩ, approximately 40 mΩ, approximately 50 mΩ, approximately 100 mΩ, approximately 150 mΩ, approximately 200 mΩ, approximately 250 mΩ, approximately 300 mΩ, approximately 400 mΩ, approximately 500 mΩ, Approximately 600 mΩ, approximately 700 mΩ, approximately 800 mΩ, or a range formed by any two of such values.

In some embodiments, a ratio of the minimum value to the maximum value of R is M≥approximately 0.6. In some embodiments, the ratio of the minimum value to the maximum value of R is M≥approximately 0.7. In some embodiments, the ratio M of the minimum value to the maximum value of R is approximately 0.5, approximately 0.6, approximately 0.7, approximately 0.8, approximately 0.9, approximately 1.0, or a range formed by any two of such values.

In some embodiments, M/N≥approximately 4. In some embodiments, M/N≥approximately 5. In some embodiments, M/N≥approximately 6. In some embodiments, M/N is approximately 4, approximately 5, approximately 6, approximately 7, approximately 8, approximately 9, approximately 10, or a range formed by any two of such values.

In some embodiments, the percentage N of the weight of the silicon-based particles in the total weight of the silicon-based particles and the graphite particles is approximately 2 wt %˜80 wt %. In some embodiments, the percentage N of the weight of the silicon-based particles in the total weight of the silicon-based particles and the graphite particles is approximately 10 wt %˜70 wt %. In some embodiments, the percentage N of the weight of the silicon-based particles in the total weight of the silicon-based particles and the graphite particles is approximately 2 wt %, approximately 3 wt %, approximately 4 wt %, approximately 5 wt %, approximately 10 wt %, Approximately 15 wt %, approximately 20 wt %, approximately 25 wt %, approximately 30 wt %, approximately 40 wt %, approximately 50 wt %, approximately 60 wt %, approximately 70 wt %, approximately 80 wt %, or a range formed by any two of such values.

In some embodiments, in an X-ray diffraction pattern of the silicon-based particles, a highest intensity value of 2θ attributed to a range of approximately 28.0°˜29.0° is I2, and a highest intensity value attributed to a range of approximately 20.5°˜21.5° is I1, and approximately 0<I2/I1≤approximately 1. In some embodiments, an I2/I1 ratio value is approximately 0.2, approximately 0.3, approximately 0.4, approximately 0.5, approximately 0.6, approximately 0.7, approximately 0.8, approximately 0.9, approximately 1, or a range formed by any two of such values.

In some embodiments, an average particle size of the silicon-based particles is approximately 500 nm˜30 μm. In some embodiments, the average particle size of the silicon-based particles is approximately 1 μm˜25 μm. In some embodiments, the average particle size of the silicon-based particles is approximately 0.5 μm, approximately 1 μm, approximately 5 μm, approximately 10 μm, approximately 15 μm, approximately 20 μm, approximately 25 μm, approximately 30 μm, or a range formed by any two of such values.

In some embodiments, the particle size distribution of the silicon-based particles satisfies: approximately 0.3≤Dn10/Dv50≤approximately 0.6. In some embodiments, the particle size distribution of the silicon-based particles satisfies: approximately 0.4≤Dn10/Dv50≤approximately 0.5. In some embodiments, the particle size distribution of the silicon-based particles is approximately 0.3, approximately 0.35, approximately 0.4, approximately 0.45, approximately 0.5, approximately 0.55, approximately 0.6, or a range formed by any two of such values.

In some embodiments, the polymer includes carboxymethyl cellulose, polyacrylic acid, polyvinylpyrrolidone, polyaniline, polyimide, polyamideimide, polysiloxane, polystyrene butadiene rubber, epoxy resin, polyester resin, polyurethane resin, polyfluorene, or any combination thereof.

In some embodiments, the silicon-containing substrate includes SiOₓ, where 0.6≤x≤1.5.

In some embodiments, the silicon-containing substrate includes Si, SiO, SiO₂, SiC, or any combination thereof.

In some embodiments, the particle size of Si is less than approximately 100 nm. In some embodiments, the particle size of Si is less than approximately 50 nm. In some embodiments, the particle size of Si is less than approximately 20 nm. In some embodiments, the particle size of Si is less than approximately 5 nm. In some embodiments, the particle size of Si is less than approximately 2 nm. In some embodiments, the particle size of Si is less than approximately 0.5 nm. In some embodiments, the particle size of Si is approximately 10 nm, approximately 20 nm, approximately 30 nm, approximately 40 nm, approximately 50 nm, approximately 60 nm, approximately 70 nm, approximately 80 nm, approximately 90 nm, or a range formed by any two of such values.

In some embodiments, based on the total weight of the silicon-based particles, the content of the polymer layer is approximately 0.05˜15 wt %. In some embodiments, based on the total weight of the silicon-based particles, the content of the polymer layer is approximately 1˜10 wt %. In some embodiments, based on the total weight of the silicon-based particles, the content of the polymer layer is approximately 2 wt %, approximately 3 wt %, approximately 4 wt %, approximately 5 wt %, approximately 6 wt %, approximately 7 wt %, approximately 8 wt %, approximately 9 wt %, approximately 10 wt %, approximately 11 wt %, approximately 12 wt %, approximately 13 wt %, approximately 14 wt %, approximately 14 wt %, or a range formed by any two of such values.

In some embodiments, a thickness of the polymer layer is approximately 5 nm˜200 nm. In some embodiments, the thickness of the polymer layer is approximately 10 nm˜150 nm. In some embodiments, the thickness of the polymer layer is approximately 50 nm˜100 nm. In some embodiments, the thickness of the polymer layer is approximately 5 nm, approximately 10 nm, approximately 20 nm, approximately 30 nm, approximately 40 nm, approximately 50 nm, approximately 60 nm, approximately 70 nm, approximately 80 nm, approximately 90 nm, approximately 100 nm, approximately 110 nm, approximately 120 nm, Approximately 130 nm, approximately 140 nm, approximately 150 nm, approximately 160 nm, approximately 170 nm, approximately 180 nm, approximately 190 nm, approximately 200 nm, or a range formed by any two of such values.

In some embodiments, the carbon nanotubes include a single-walled carbon nanotube, a multi-walled carbon nanotube, or a combination thereof.

In some embodiments, based on the total weight of the silicon-based particles, a content of the carbon nanotubes is approximately 0.01˜10 wt %. In some embodiments, based on the total weight of the silicon-based particles, the content of the carbon nanotubes is approximately 1˜8 wt %. In some embodiments, based on the total weight of the silicon-based particles, the content of the carbon nanotubes is approximately 0.01 wt %, approximately 0.02 wt %, approximately 0.05 wt %, approximately 0.1 wt %, approximately 0.5 wt %, approximately 1 wt %, approximately 1.5 wt %, approximately 2 wt %, approximately 2 wt %, approximately 3 wt %, approximately 4 wt %, approximately 5 wt %, approximately 6 wt %, approximately 7 wt %, approximately 8 wt %, approximately 9 wt %, approximately 10 wt %, or a range formed by any two of such values.

In some embodiments, a weight ratio of the polymer to the carbon nanotubes in the polymer layer is approximately 0.5:1˜10:1. In some embodiments, the weight ratio of the polymer to the carbon material in the polymer layer is approximately 1:1, approximately 2:1, approximately 3:1, approximately 4:1, approximately 5:1, approximately 6:1, approximately 7:1, approximately 8:1, approximately 9:1, approximately 10:1, or a range formed by any two of such values.

In some embodiments, a diameter of the carbon nanotubes is approximately 1˜30 nm. In some embodiments, the diameter of the carbon nanotubes is approximately 5˜20 nm. In some embodiments, the diameter of the carbon nanotubes is approximately 10 nm, approximately 15 nm, approximately 20 nm, approximately 25 nm, approximately 30 nm, or a range formed by any two of such values.

In some embodiments, a length-to-diameter ratio of the carbon nanotubes is approximately 50˜30,000. In some embodiments, the length-to-diameter ratio of the carbon nanotubes is approximately 100˜20,000. In some embodiments, the length-to-diameter ratio of the carbon nanotubes is approximately 500, approximately 2,000, approximately 5,000, approximately 10,000, approximately 15,000, approximately 2,000, approximately 25,000, approximately 30,000, or a range formed by any two of such values.

In some embodiments, a specific surface area of the silicon-based particles is approximately 1˜50 m²/g, for example, approximately 2.5˜15 m²/g. In some embodiments, the specific surface area of the silicon-based particles is approximately 5˜10 m²/g. In some embodiments, the specific surface area of the silicon-based particles is approximately 3 m²/g, approximately 4 m²/g, approximately 6 m²/g, approximately 8 m²/g, approximately 10 m²/g, approximately 12 m²/g, approximately 14 m²/g, or a range formed by any two of such values.

In some embodiments, this application provides a method for preparing any one of the foregoing silicon-based particles. The method includes:

(1) adding carbon nanotubes into a polymer-containing solution, and dispersing the powder for approximately 1˜24 hours to obtain a slurry;

(2) adding a silicon-containing substrate into the slurry, and dispersing the substrate for approximately 2˜10 hours to obtain a mixed slurry;

(3) removing a solvent in the mixed slurry; and

(4) crushing and sifting the mixed slurry.

In some embodiments, definitions of the silicon-containing substrate, carbon nanotubes, and a polymer are as described above, respectively.

In some embodiments, the weight ratio of the polymer to the carbon nanotubes is approximately 1:1˜10:1. In some embodiments, the weight ratio of the polymer to the carbon material in the polymer layer is approximately 1:1, approximately 2:1, approximately 3:1, approximately 4:1, approximately 5:1, approximately 6:1, approximately 7:1, approximately 8:1, approximately 9:1, approximately 10:1, or a range formed by any two of such values.

In some embodiments, the weight ratio of the silicon-containing substrate to the polymer is approximately 200:1˜10:1. In some embodiments, the weight ratio of the silicon-containing substrate to the polymer is approximately 150:1˜20:1. In some embodiments, the weight ratio of the silicon-containing substrate to the polymer is approximately 200:1, approximately 150:1, approximately 100:1, approximately 50:1, approximately 10:1, or a range formed by any two of such values.

In some embodiments, the solvent includes water, ethanol, methanol, n-hexane, N,N-dimethylformamide, pyrrolidone, acetone, toluene, isopropanol, or any combination thereof.

In some embodiments, a dispersion time in step (1) is approximately 1 h, approximately 5 h, approximately 10 h, approximately 15 h, approximately 20 h, approximately 24 h, or a range formed by any two of such values.

In some embodiments, the dispersion time in step (2) is approximately 2 h, approximately 2.5 h, approximately 3 h, approximately 3.5 h, approximately 4 h, approximately 5 h, approximately 6 h, approximately 7 h, approximately 8 h, approximately 9 h, approximately 10 h, or a range formed by any two of such values.

In some embodiments, the method for removing the solvent in step (3) includes rotary evaporation, spray drying, filtering, freeze-drying, or any combination thereof.

In some embodiments, the sifting in step (4) is performed through a 400-mesh sieve.

In some embodiments, the silicon-containing substrate may be a commercially available silicon oxide SiOₓ, or may be a silicon oxide SiOₓ prepared according to the method of this application and satisfying approximately 0<I2/I1≤approximately 1, where the preparation method includes:

(1) mixing the silicon dioxide and metal silicon powder at a molar ratio of approximately 1:5˜5:1 to obtain a mixed material;

(2) heating the mixed material in a temperature range of approximately 1,100˜1,500° C. and in a pressure range of approximately 10⁻⁴˜10⁻¹ kPa for approximately 0.5˜24 h to obtain a gas;

(3) condensing the obtained gas to obtain a solid;

(4) crushing and sifting the solid to obtain the silicon-based particles; and

(5) thermally treating the solid in a temperature range of approximately 400˜1,200° C. for approximately 1˜24 h, and cooling the thermally treated solid to obtain the silicon-based particles.

In some embodiments, a molar ratio of the silicon dioxide to the metal silicon powder is approximately 1:4˜4:1. In some embodiments, a molar ratio of the silicon dioxide to the metal silicon powder is approximately 1:3˜3:1. In some embodiments, the molar ratio of the silicon dioxide to the metal silicon powder is approximately 1:2˜2:1. In some embodiments, the molar ratio of the silicon dioxide to the metal silicon powder is approximately 1:1.

In some embodiments, the pressure range is approximately 10⁻⁴˜10⁻¹ kPa. In some embodiments, the pressure is approximately 1 Pa, approximately 10 Pa, approximately 20 Pa, approximately 30 Pa, approximately 40 Pa, approximately 50 Pa, approximately 60 Pa, approximately 70 Pa, approximately 80 Pa, approximately 90 Pa, approximately 100 Pa, or a range formed by any two of such values.

In some embodiments, the heating temperature is approximately 1,100˜1,450° C. In some embodiments, the heating temperature is approximately 1,200° C., approximately 1,300° C., approximately 1,400° C., approximately 1,500° C., approximately 1,600° C., or a range formed by any two of such values.

In some embodiments, the heating time is approximately 1˜20 h. In some embodiments, the heating time is approximately 5˜15 h. In some embodiments, the heating time is approximately 2 h, approximately 4 h, approximately 6 h, approximately 8 h, approximately 10 h, approximately 12 h, approximately 14 h, approximately 16 h, approximately 18 h, or a range formed by any two of such values.

In some embodiments, the mixing is performed by using a ball mill, a V-shaped mixer, a three-dimensional mixer, an air flow mixer, or a horizontal agitator.

In some embodiments, the heating is performed under inert gas protection. In some embodiments, the inert gas includes nitrogen, argon, helium, or a combination thereof.

In some embodiments, the thermal treatment temperature is approximately 400˜1,200° C. In some embodiments, the thermal treatment temperature is approximately 400° C., approximately 600° C., approximately 800° C., approximately 1,000° C., approximately 1,200° C., or a range formed by any two of such values.

In some embodiments, the thermal treatment time is approximately 1˜24 h. In some embodiments, the thermal treatment time is approximately 2˜12 h. In some embodiments, the thermal treatment time is approximately 2 h, approximately 5 h, approximately 10 h, approximately 15 h, approximately 20 h, approximately 24 h, or a range formed by any two of such values.

In some embodiments, this application provides a method for preparing a negative electrode. The method includes:

(1) mixing the silicon-based particles disclosed in any of the foregoing embodiments with graphite, and dispersing the mixture at a rotation speed of 10˜100 r/min for 0.1˜2 h to obtain a mixed negative active material;

(2) adding a binder, a solvent, and a conductive agent into the mixed negative active material obtained in step (1), stirring the mixture at a rotation speed of 10˜100 r/min for 0.5˜3 h, and dispersing the mixture at a rotation speed of 300˜2,500 r/min for 0.5˜3 h to obtain a negative electrode slurry; and

(3) coating the negative electrode slurry onto the current collector, and performing drying and cold calendering to obtain a negative electrode.

In some embodiments, the solvent includes deionized water and N-methyl-pyrrolidone or any combination thereof.

In some embodiments, the binder includes: polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, nylon, or any combination thereof.

In some embodiments, the conductive agent includes: natural graphite, artificial graphite, carbon black, acetylene black, Ketjen black, carbon fiber, metal powder, metal fiber, copper, nickel, aluminum, silver, a polyphenylene derivative, or any combination thereof.

In some embodiments, the current collector includes: a copper foil, a nickel foil, a stainless steel foil, a titanium foil, foamed nickel, foamed copper, a polymer substrate coated with a conductive metal, or any combination thereof.

In some embodiments, the weight ratio of the silicon-based particles to the graphite particles is approximately 10:1˜1:20. In some embodiments, the weight ratio of the silicon-based particles to the graphite particles is approximately 10:1, approximately 8:1, approximately 5:1, approximately 3:1, approximately 1:1, approximately 1:3, approximately 1:5, approximately 1:8, approximately 1:10, approximately 1:12, approximately 1:15, approximately 1:18, approximately 1:20, or a range formed by any two of such values.

In some embodiments, the weight ratio of the binder to the silicon-based particles is approximately 1:10˜2:1. In some embodiments, the weight ratio of the binder to the silicon-based particles is approximately 1:10, approximately 1:9, approximately 1:8, approximately 1:7, approximately 1:6, approximately 1:5, approximately 1:4, approximately 1:3, approximately 1:2, approximately 1:1, approximately 2:1, or a range formed by any two of such values.

In some embodiments, the weight ratio of the conductive agent to the silicon-based particles is approximately 1:100˜1:10. In some embodiments, the weight ratio of the binder to the silicon-based particles is approximately 1:100, approximately 1:90, approximately 1:80, approximately 1:70, approximately 1:60, approximately 1:50, approximately 1:40, approximately 1:30, approximately 1:20, approximately 1:10, or a range formed by any two of such values.

The silicon-based negative electrode material has a gram capacity of 1,500˜4,200 mAh/g, and is considered to be the most promising next-generation negative electrode material of lithium-ion batteries. However, low conductivity of silicon, an approximately 300% volume expansion rate of the silicon-based negative electrode material in a charge and discharge process, and an unstable solid electrolyte interphase membrane (SEI) of the material hinder further application of the silicon-based negative electrode material to some extent. Currently, the cycle stability and the rate performance of the silicon-based materials can be improved by using carbon nanotubes (CNTs).

However, the inventor of this application finds that the CNTs are difficult to disperse, and are prone be entangled with a plurality of silicon particles during dispersion performed after the CNTs are mixed with silicon. The entanglement leads to agglomeration of silicon particles, and ultimately results in inhomogeneous dispersion of the silicon particles in graphite. In a region where the silicon particles are agglomerated, the electrolytic solution is severely consumed and polarization increases, thereby deteriorating the cycle performance of the battery. In addition, in the region where the silicon particles are agglomerated, the volume expands greatly during charging and discharging. Consequently, the separator is prone to be penetrated and is at risk of a short circuit.

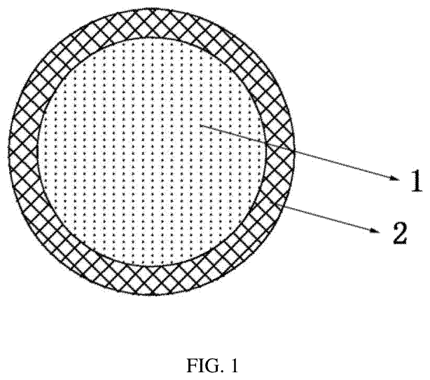

To overcome the foregoing problems, the inventor of this application firstly coats the surface of the silicon-containing substrate with the composite layer of the polymer and the CNT. As shown in the schematic structural diagram of the silicon-based negative active material in FIG. 1, an inner layer 1 is a silicon-containing substrate, and an outer layer 2 is a polymer layer including carbon nanotubes. The polymer layer including the carbon nanotubes coats the surface of the silicon-containing substrate. The carbon nanotubes may be bound onto the surface of the silicon-based particles by using the polymer, thereby helping to improve interface stability of the carbon nanotubes on the surface of the negative active material and enhance the cycle stability. In addition, because the CNTs are bound by the polymer onto the surface of the silicon-based negative active material, the CNTs are not prone to be entangled with other silicon-based particles, so that the silicon-based particles can be homogeneously dispersed in the graphite. In this case, the graphite can effectively relieve a volume change of the silicon-based particles during charging and discharging, thereby reducing battery expansion and improving battery safety.

A minimum value of film resistances located at different positions on the coating surface of the negative current collector is R1, a maximum value is R2, and a value of an R1/R2 ratio is M. The larger the value of M, the more homogeneously the film resistances are distributed, and the more homogeneously the silicon is dispersed in the graphite. The percentage of the weight of the silicon-based particles of the negative electrode in the total weight of the silicon-based particles and the graphite particles is N.

The inventor of this application finds that, when the negative electrode satisfies M≥approximately 0.5 and N is approximately 2 wt %˜80 wt %, the lithium-ion battery prepared by using the negative electrode achieves higher cycle performance, higher rate performance, a higher strain-resistant capability, and a lower direct-current resistance.

The inventor of this application also finds that the I2/I1 ratio value in the silicon-based negative active material reflects a degree of impact caused by material disproportionation. The higher the I2/I1 ratio value, the larger the size of the nano-silicon crystal grains inside the silicon-based negative active material. Dn10/Dv50 is a ratio of Dn10 to Dv50, where Dn10 represents a particle diameter of a material at a cumulative number of 10% in a number-based particle size distribution as measured by a laser scattering particle size analyzer, and Dv50 represents a particle diameter of the material at a cumulative volume of 50% in a volume-based particle size distribution. The higher the ratio, the fewer the small particles in the material. Under a condition that M≥approximately 0.5 and N is approximately 2 wt %˜80 wt %, in contrast with a case in which the I2/I1 ratio value is higher than 1 and the Dn10/Dv50 ratio is not within the range of 0.3˜0.6, the lithium-ion battery prepared by using the silicon-based negative active material achieves even higher cycle performance, higher rate performance, and a higher strain-resistant capability in a case that the I2/I1 ratio value satisfies 0<I2/I1≤1 and 0.3≤Dn10/Dv50≤0.6.

II. Positive Electrode

The material, composition, and manufacturing method of the positive electrode that are applicable to the embodiments of this application include any technology disclosed in the prior art. In some embodiments, the positive electrode is the positive electrode specified in the US patent application U.S. Pat. No. 9,812,739B, which is incorporated herein by reference in its entirety.

In some embodiments, the positive electrode includes a current collector and a positive active material layer disposed on the current collector.

In some embodiments, the positive active material includes, but is not limited to, lithium cobalt oxide (LiCoO₂), a lithium nickel-cobalt-manganese (NCM) ternary material, lithium ferrous phosphate (LiFePO₄), or lithium manganese oxide (LiMn₂O₄).

In some embodiments, the positive active material layer further includes a binder, and optionally includes a conductive material. The binder improves bonding between particles of the positive-electrode active material and bonding between the positive-electrode active material and a current collector.

In some embodiments, the binder includes, but is not limited to: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, or nylon.

In some embodiments, the conductive material includes, but is not limited to, a carbon-based material, a metal-based material, a conductive polymer, and a mixture thereof. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector may include, but is not limited to aluminum.

The positive electrode may be prepared according to a preparation method known in the art. For example, the positive electrode may be obtained according to the following method: mixing an active material, a conductive material, and a binder in a solvent to prepare an active material composite, and coating the active material composite onto the current collector. In some embodiments, the solvent may include, but is not limited to N-methyl-pyrrolidone.

III. Electrolytic Solution

The electrolytic solution applicable to the embodiments of this application may be an electrolytic solution known in the prior art.

In some embodiments, the electrolytic solution includes an organic solvent, a lithium salt, and an additive. The organic solvent of the electrolytic solution according to this application may be any organic solvent known in the prior art that can be used as a solvent of the electrolytic solution. An electrolyte used in the electrolytic solution according to this application is not limited, and may be any electrolyte known in the prior art. The additive of the electrolytic solution according to this application may be any additive known in the prior art that can be used as an additive of the electrolytic solution.

In some embodiments, the organic solvent includes, but is not limited to: ethylene carbonate (EC), propylene carbonate (PC), diethyl carbonate (DEC), ethyl methyl carbonate (EMC), dimethyl carbonate (DMC), propylene carbonate, or ethyl propionate.

In some embodiments, the lithium salt includes at least one of an organic lithium salt or an inorganic lithium salt.

In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN (CF₃SO₂)₂ (LiTFSI), lithium bis(fluorosulfonyl)imide Li(N(SO₂F)₂) (LiFSI), lithium bis(oxalate) borate LiB(C₂O₄)₂ (LiBOB), or lithium difluoro(oxalate)borate LiBF₂(C₂O₄) (LiDFOB).

In some embodiments, a concentration of the lithium salt in the electrolytic solution is approximately 0.5˜3 mol/L, approximately 0.5˜2 mol/L, or approximately 0.8˜1.5 mol/L.

IV. Separator

In some embodiments, a separator is disposed between the positive electrode and the negative electrode to prevent short circuit. The material and the shape of the separator applicable to the embodiments of this application are not particularly limited, and may be based on any technology disclosed in the prior art. In some embodiments, the separator includes a polymer or an inorganic compound or the like formed from a material that is stable to the electrolytic solution according to this application.

For example, the separator may include a substrate layer and a surface treatment layer. The substrate layer is a non-woven fabric, film or composite film, which, in each case, have a porous structure. The material of the substrate layer is selected from at least one of polyethylene, polypropylene, polyethylene terephthalate, and polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

A surface treatment layer is disposed on at least one surface of the substrate layer. The surface treatment layer may be a polymer layer or an inorganic substance layer, or a layer formed by mixing a polymer and an inorganic substance.

The inorganic compound layer includes inorganic particles and a binder. The inorganic particles are selected from a combination of one or more of an aluminum oxide, a silicon oxide, a magnesium oxide, a titanium oxide, a hafnium dioxide, a tin oxide, a ceria, a nickel oxide, a zinc oxide, a calcium oxide, a zirconium oxide, an yttrium oxide, a silicon carbide, a boehmite, an aluminum hydroxide, a magnesium hydroxide, a calcium hydroxide, and a barium sulfate. The binder is selected from a combination of one or more of a polyvinylidene fluoride, a vinylidene fluoride-hexafluoropropylene copolymer, a polyamide, a polyacrylonitrile, a polyacrylate, a polyacrylic acid, a polyacrylate, a polyvinylpyrrolidone, a polyvinyl ether, a poly methyl methacrylate, a polytetrafluoroethylene, and a polyhexafluoropropylene.

The polymer layer includes a polymer, and the material of the polymer is selected from at least one of a polyamide, a polyacrylonitrile, an acrylate polymer, a polyacrylic acid, a polyacrylate, a polyvinylpyrrolidone, a polyvinyl ether, a polyvinylidene fluoride, or a poly(vinylidene fluoride-hexafluoropropylene).

V. Electrochemical Device

An embodiment of this application provides an electrochemical device. The electrochemical device includes any device in which an electrochemical reaction occurs.

In some embodiments, the electrochemical device according to this application includes: a positive electrode that contains a positive active material capable of occluding and releasing metal ions; a negative electrode according to the embodiment of this application; an electrolytic solution; and a separator disposed between the positive electrode and the negative electrode.

In some embodiments, the electrochemical device according to this application includes, but is not limited to: any type of primary battery, secondary battery, fuel battery, solar battery, or capacitor.

In some embodiments, the electrochemical device is a lithium secondary battery.

In some embodiments, the lithium secondary battery includes, but is not limited to, a lithium metal secondary battery, a lithium-ion secondary battery, a lithium polymer secondary battery, or a lithium-ion polymer secondary battery.

VI. Electronic Device

The electronic device according to this application may be any device that uses the electrochemical device according to the embodiment of this application.

In some embodiments, the electronic device includes, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, or the like.

The following describes preparation of a lithium-ion battery as an example with reference to specific embodiments. A person skilled in the art understands that the preparation method described in this application are merely examples. Any other appropriate preparation methods fall within the scope of this application.

### Embodiments

The following describes performance evaluation of the lithium-ion batteries according to the embodiments and comparative embodiments of this application.

I. Test Methods

1. Testing high-temperature cycle performance: charging the battery at a 0.7 C constant current under a 45° C. until the voltage reaches 4.4 V; charging the battery at a constant voltage until the current reaches 0.025 C; leaving the battery to stand for 5 minutes, and then discharging the battery at a 0.5 C current until the voltage reaches 3.0 V. performing a 0.7 C charging/0.5 C discharging cycle test by using the capacity obtained in this step as an initial capacity; and obtaining a capacity fading curve by using a ratio of the capacity obtained in each step to the initial capacity; recording the quantity of cycles when the capacity retention rate reaches 80% in the cycle test at 45° C. to compare the high-temperature cycle performance of the battery.

2. Testing an expansion rate of the battery: using a spiral micrometer to measure a thickness of a fresh battery half charged (at a 50% state of charge (SOC)); when the battery reaches the 400^{th} cycle and is in a fully charged state (100% SOC), using the spiral micrometer to measure the thickness of the battery at this time, and comparing the thickness at this time with the thickness of the fresh battery initially half charged (50% SOC), so as to obtain the expansion rate of the fully charged (100% SOC) battery at this time.

3. Testing a discharge rate: discharging the battery at a 0.2 C current and a 25° C. temperature until the voltage reaches 3.0 V; leaving the battery to stand for 5 minutes; charging the battery at 0.5 C until the voltage reaches 4.4 V; charging the battery at a constant voltage until the current reaches 0.05 C; leaving the battery to stand for 5 minutes; adjusting the discharge rate and performing discharge tests at 0.2 C, 0.5 C, 1 C, 1.5 C, and 2.0 C separately to obtain discharge capacities; calculating a ratio of the capacity obtained at each C-rate to the capacity obtained at 0.2 C, and comparing the rate performance by comparing the ratio.

4. Testing a direct-current resistance (DCR): using a Maccor machine to test the actual capacity of the battery at 25° C. (charging the battery at a 0.7 C constant current until the voltage reaches 4.4 V, charging the battery at a constant voltage until the current reaches 0.025 C, and leaving the battery to stand for 10 minutes; discharging the battery at 0.1 C until the voltage reaches 3.0 V, and leaving the battery to stand for 5 minutes); discharging the battery to a specified SOC at 0.1 C, performing sampling every 5 ms in a discharge duration of ls, and calculating a DCR value under a 10% SOC.

5. Testing a negative electrode film resistance:

Applying a four-point probe method to measure the negative electrode film resistance by using a precision DC voltage/current source instrument (type SB118); fixing four copper plates (each sized 1.5 cm (length)×1 cm (width)×2 mm (thickness)) on one line at equal spacing, with the spacing between the two copper plates in the middle being L(1˜2 cm); and using an insulating material as a base material for fixing the copper plates; during the test, pressing lower end faces of the four copper plates on the measured negative electrode, connecting the copper plates at both ends to a DC current I, measuring the voltage V at the two copper plates in the middle, reading the I and V values for three times, and calculating an average value (Ia) of the I values and an average value (Va) of the V values, and using a Va/Ia ratio as the film resistance at the test position; and

randomly measuring the film resistance values at 100 different positions on the coating surface, with the measured positions spreading over the entire coating surface of the negative current collector, where the minimum resistance value is R1, and the maximum resistance value is R2; calculating an R1/R2 ratio, and recording the ratio as M.

6. XRD test: weighing out 1.0˜2.0 grams of a sample, pouring the sample into a groove of a glass sample holder; using a glass sheet to compact and smooth the sample, using an X-ray diffractometer (Bruker-D8) to carry out a test according to JJS K 0131-1996 General Rules for X-Ray Diffractometry; setting a test voltage to 40 kV, setting a current to 30 mA, setting a scanning angle range to 10°˜85°, setting a scanning step length to 0.0167°, and setting the time of each step length to 0.24 s, so as to obtain an XRD diffraction pattern; from the pattern, obtaining a highest intensity value I2 of 2θ attributed to 28.4° and a highest intensity I1 attributed to 21.0°, and calculating the I2/I1 ratio value.

7. Particle size test: adding 0.02 gram of a powder sample into a 50 ml clean beaker, adding 20 ml of deionized water, and then adding a few drops of 1% surfactant to fully disperse the powder in the water; performing ultrasonic cleaning in a 120 W ultrasonic cleaning machine for 5 minutes, and measuring the particle size distribution by using MasterSizer 2000.

II. Preparing a Positive Electrode

Fully stirring and homogeneously mixing LiCoO₂, conductive carbon black, and polyvinylidene fluoride (PVDF) as a binder at a weight ratio of 96.7:1.7:1.6 in an N-methyl-pyrrolidone solvent system to prepare a positive electrode slurry; and coating the prepared positive electrode slurry onto a positive current collector aluminum foil, and performing drying and cold calendering to obtain a positive electrode.

III: Preparing an Electrolytic Solution

Adding LiPF₆ into a solvent in a dry argon atmosphere, where the solvent is a mixture of propylene carbonate (PC), ethylene carbonate (EC), and diethyl carbonate (DEC) (at a weight ratio of 1:1:1); mixing the solution homogeneously, where a concentration of LiPF₆ is 1 mol/L; and then adding 10 wt % fluoroethylene carbonate (FEC), and mixing the solution homogeneously to obtain an electrolytic solution.

IV. Preparing a Separator

Using a PE porous polymer film as a separator.

V. Preparing a Negative Electrode

1. Using the following method to prepare the silicon-based negative active materials disclosed in Embodiments 1˜10, Embodiments 13˜19, and Comparative Embodiments 2˜6:

(1) mixing the silicon dioxide and metal silicon powder at a molar ratio of 1:1 through mechanical dry mixing and ball mill mixing separately to obtain a mixed material;

(2) heating the mixed material in an Ar₂ atmosphere in a temperature range of 1,100˜1,550° C. and in a pressure range of approximately 10⁻³˜10⁻¹ kPa for 0.5˜24 h to obtain a gas;

(3) condensing the obtained gas to obtain a solid, and pulverizing and sifting the solid; and

(4) Thermally treating the solid in a nitrogen atmosphere in a temperature range of 400˜1,200° C. for 1˜24 hours, and cooling the thermally treated solid to obtain a silicon-containing substrate material that has different I2/I1 ratio values, with an average particle size Dv50 being 5.2 μm;

(5) dispersing carbon nanotubes (CNTs) and a polymer in water at a high speed for 12 hours to obtain a homogeneously mixed slurry;

(6) adding the silicon-containing substrate material into the slurry homogeneously mixed in step (5), and stirring the slurry for 4 hours to obtain a homogeneously mixed dispersed solution;

(7) spray-drying (at an inlet temperature of 200° C., and an outlet temperature of 110° C.) the dispersed solution to obtain powder; and

(8) cooling the powder, and taking out the powder sample; and pulverizing and sifting the powder sample to obtain silicon-based particles as a silicon-based negative active material.

The method for preparing the silicon-based negative active material in Comparative Embodiment 1 is similar to the foregoing preparation method, except that in Comparative Embodiment 1, no carbon nanotubes are added in step (5).

The method for preparing the silicon-based negative active material in Embodiments 11 and 12 is similar to the foregoing preparation method, except that the silicon-containing substrate in Embodiments 11 and 12 is SiC.

2. Using the following method to prepare the negative electrode disclosed in Embodiments 1˜15 and Comparative Embodiments 2˜6:

(1) mixing 100 grams of the silicon-based negative active material disclosed in Embodiments 1˜15 and Comparative Embodiments 2˜6 with 25˜1,900 grams of graphite, and dispersing the mixture at a rotation speed of 20 r/min for 1 hour to obtain a mixed negative active material;

(2) adding a binder, deionized water, and a conductive agent into the mixed negative active material obtained in step (1), stirring the mixture at a rotation speed of 15 r/min for 2 hours, and dispersing the mixture at a rotation speed of 1,500 r/min for 1 hour to obtain a negative electrode slurry; and

(3) coating the negative electrode slurry onto a copper foil, and performing drying and cold calendering to obtain a negative electrode.

The method for preparing the negative electrode in Comparative Embodiment 1 is similar to the foregoing preparation method, except that in Step (1) in Comparative Embodiment 1, the silicon-based negative active material and graphite are further mixed with CNTs.

VI. Preparing a Lithium-Ion Battery

Stacking the positive electrode, the separator, and the negative electrode sequentially, placing the separator between the positive electrode and the negative electrode to serve a function of separation, and winding the stacked materials to obtain a bare cell; putting the bare cell into an outer package, injecting an electrolytic solution, and packaging the bare cell; and performing formation, degassing, edge trimming, and other technical processes to obtain a lithium-ion battery.

Table 1 shows specific technical parameters in steps (1) to (4) in the method for preparing the silicon-based negative active materials disclosed in Embodiments 1˜10, Embodiments 13˜19, and Comparative Embodiments 1˜6.

TABLE 1

| | | Heating | | | Thermal |
|---|---|---|---|---|---|
| Serial | Pressure | temperature | Heating | | processing |
| number | (Pa) | (° C.) | time (h) | Grading | after grading |
| Embodiment | 10 | 1350 | 20 | Airflow pulverization + | 600° C., 2 h |
| 1 | | | | grading for a plurality | |
| | | | | of times | |
| Embodiment | 10 | 1350 | 20 | Airflow pulverization + | 600° C., 2 h |
| 2 | | | | grading for a plurality | |
| | | | | of times | |
| Embodiment | 10 | 1350 | 20 | Airflow pulverization + | 600° C., 2 h |
| 3 | | | | grading for a plurality | |
| | | | | of times | |
| Embodiment | 10 | 1350 | 20 | Airflow pulverization + | 600° C., 2 h |
| 4 | | | | grading for a plurality | |
| | | | | of times | |
| Embodiment | 10 | 1350 | 20 | Airflow pulverization + | 600° C., 2 h |
| 5 | | | | grading for a plurality | |
| | | | | of times | |
| Embodiment | 10 | 1350 | 20 | Airflow pulverization + | 600° C., 2 h |
| 6 | | | | grading for a plurality | |
| | | | | of times | |
| Embodiment | 10 | 1350 | 20 | Airflow pulverization + | 600° C., 2 h |
| 7 | | | | grading for a plurality | |
| | | | | of times | |
| Embodiment | 10 | 1350 | 20 | Airflow pulverization + | 600° C., 2 h |
| 8 | | | | grading for a plurality | |
| | | | | of times | |
| Embodiment | 10 | 1350 | 20 | Airflow pulverization + | 600° C., 2 h |
| 9 | | | | grading for a plurality | |
| | | | | of times | |
| Embodiment | 10 | 1350 | 20 | Airflow pulverization + | 600° C., 2 h |
| 10 | | | | grading for a plurality | |
| | | | | of times | |
| Embodiment | 10 | 1350 | 20 | Airflow pulverization + | 600° C., 2 h |
| 13 | | | | grading for a plurality | |
| | | | | of times | |
| Embodiment | 10 | 1350 | 20 | Airflow pulverization + | 600° C., 2 h |
| 14 | | | | grading for a plurality | |
| | | | | of times | |
| Embodiment | 10 | 1350 | 20 | Airflow pulverization + | 600° C., 2 h |
| 15 | | | | grading for a plurality | |
| | | | | of times | |
| Embodiment | 10 | 1350 | 20 | Airflow pulverization + | |
| 16 | | | | grading for a plurality | |
| | | | | of times | |
| Embodiment | 10 | 1350 | 20 | Airflow pulverization + | 800° C., 2 h |
| 17 | | | | grading for a plurality | |
| | | | | of times | |
| Embodiment | 10 | 1350 | 20 | Airflow pulverization + | 600° C., 2 h |
| 18 | | | | grading for a plurality | |
| | | | | of times | |
| Embodiment | 10 | 1350 | 20 | Airflow pulverization + | 600° C., 2 h |
| 19 | | | | grading for a plurality | |
| | | | | of times | |
| Comparative | 10 | 1350 | 20 | Airflow pulverization + | 600° C., 2 h |
| Embodiment | | | | grading for a plurality | |
| 1 | | | | of times | |
| Comparative | 10 | 1350 | 20 | Airflow pulverization + | 600° C., 2 h |
| Embodiment | | | | grading for a plurality | |
| 2 | | | | of times | |
| Comparative | 10 | 1350 | 20 | Airflow pulverization + | 600° C., 2 h |
| Embodiment | | | | grading for a plurality | |
| 3 | | | | of times | |
| Comparative | 10 | 1350 | 20 | Airflow pulverization + | 1000° C., 2 h |
| Embodiment | | | | grading for a plurality | |
| 4 | | | | of times | |
| Comparative | 10 | 1350 | 20 | Airflow pulverization + | 600° C., 2 h |
| Embodiment | | | | grading for a plurality | |
| 5 | | | | of times | |
| Comparative | 10 | 1350 | 20 | Airflow pulverization + | 600° C., 2 h |
| Embodiment | | | | grading for a plurality | |
| 6 | | | | of times | |

Table 2 shows the types and dosages of various substances used in the method for preparing the silicon-based negative active materials disclosed in Embodiments 1˜19 and Comparative Embodiments 1˜6, and the types and dosages of the graphite, polymer, binder, and conductive agent used in the method for preparing the negative electrodes disclosed in Embodiments 1˜19 and Comparative Embodiments 1˜6.

TABLE 2

| | Silicon-containing | | | | | |
|---|---|---|---|---|---|---|
| Serial number | substrate | CNT | Graphite | Polymer | Binder | Conductive agent |
| Embodiment 1 | SiO/100 g | 0.5 g | 900 g | CMC/0.75 g | PAA/50 g | Conductive carbon black/2 g |
| Embodiment 2 | SiO/100 g | 1 g | 900 g | CMC/1.5 g | PAA/50 g | Conductive carbon black/2 g |
| Embodiment 3 | SiO/100 g | 2 g | 900 g | CMC/3 g | PAA/50 g | Conductive carbon black/2 g |
| Embodiment 4 | SiO/100 g | 1 g | 900 g | CMC/1.5 g | PAA/50 g | — |
| Embodiment 5 | SiO/100 g | 1 g | 900 g | CMC/0.5 g | PAA/50 g | Conductive carbon black/2 g |
| Embodiment 6 | SiO/100 g | 1 g | 900 g | CMC/1 g | PAA/50 g | Conductive carbon black/2 g |
| Embodiment 7 | SiO/100 g | 1 g | 900 g | CMC/3 g | PAA50/g | Conductive carbon black/2 g |
| Embodiment 8 | SiO/100 g | 1 g | 1900 g | CMC/1.5 g | PAA/100 g | Conductive carbon black/2 g |
| Embodiment 9 | SiO/100 g | 1 g | 400 g | CMC/1.5 g | PAA/25 g | Conductive carbon black/2 g |
| Embodiment | SiO/100 g | 1 g | 150 g | CMC/1.5 g | PAA/12.5 g | Conductive carbon black/2 g |
| 10 | | | | | | |
| Embodiment | SiC/100 g | 1 g | 900 g | CMC/1.5 g | PAA/50 g | Conductive carbon black/2 g |
| 11 | | | | | | |
| Embodiment | SiC/100 g | 2 g | 900 g | CMC/3 g | PAA/50 g | Conductive carbon black/2 g |
| 12 | | | | | | |
| Embodiment | SiO/100 g | 1 g | 900 g | PAA/1.5 g | PAA/50 g | Conductive carbon black/2 g |
| 13 | | | | | | |
| Embodiment | SiO/100 g | 1 g | 900 g | PVP/1.5 g | PAA/50 g | Conductive carbon black/2 g |
| 14 | | | | | | |
| Embodiment | SiO/100 g | 1 g | 900 g | PAA/0.75 g + | PAA/50 g | Conductive carbon black/2 g |
| 15 | | | | CMC/0.75 g | | |
| Embodiment | SiO/100 g | 1 g | 900 g | CMC/1.5 g | PAA/50 g | Conductive carbon black/2 g |
| 16 | | | | | | |
| Embodiment | SiO/100 g | 1 g | 900 g | CMC/1.5 g | PAA/50 g | Conductive carbon black/2 g |
| 17 | | | | | | |
| Embodiment | SiO/100 g | 1 g | 900 g | CMC/1.5 g | PAA/50 g | Conductive carbon black/2 g |
| 18 | | | | | | |
| Embodiment | SiO/100 g | 1 g | 900 g | CMC/1.5 g | PAA/50 g | Conductive carbon black/2 g |
| 19 | | | | | | |
| Comparative | SiO/100 g | 1 g | 900 g | CMC/1.5 g | PAA/50 g | Conductive carbon black/2 g |
| Embodiment 1 | | | | | | |
| Comparative | SiO/100 g | — | 900 g | — | PAA/50 g | Conductive carbon black/2 g |
| Embodiment 2 | | | | | | |
| Comparative | SiO/100 g | 5 g | 900 g | CMC/7.5 g | PAA/50 g | Conductive carbon black/2 g |
| Embodiment 3 | | | | | | |
| Comparative | SiO/100 g | 1 g | 900 g | CMC/1.5 g | PAA/50 g | Conductive carbon black/2 g |
| Embodiment 4 | | | | | | |
| Comparative | SiO/100 g | 1 g | 900 g | CMC/1.5 g | PAA/50 g | Conductive carbon black/2 g |
| Embodiment 5 | | | | | | |
| Comparative | SiO/100 g | 1 g | 900 g | CMC/1.5 g | PAA/50 g | Conductive carbon black/2 g |
| Embodiment 6 | | | | | | |

“—” means that this substance is not added in the preparation process.

The full names of the abbreviations used in Table 2 are as follows:

CMC: Carboxymethyl cellulose

PAA: Polyacrylic acid

Table 3 shows the relevant performance parameters of the silicon-based negative active materials disclosed in Embodiments 1˜19 and Comparative Embodiments 1˜6, where N is a percentage of the weight of the silicon-based negative active material in the total weight of the silicon-based negative active material and the graphite in the negative electrode.

TABLE 3

| | | | | | | | | | | | | C-rate | DCR |
|---|---|---|---|---|---|---|---|---|---|---|---|---|---|
| | | | | | | | | | | | Expansion | (2 C | (measured |
| | | | | | | | | | | | of the fully | discharge | at a room |
| | | | | | | | | Specific | Thickness | Quantity of | charged | capacity/ | temperature |
| | | | | | | | | surface | of the | cycles when | battery | 0.2 C | when the |
| Serial | R₁ | R₂ | | | I₂/I₁ ratio | Dv50 | Dn10/ | area | polymer | the capacity | after 400 | discharge | SOC is 10%, |
| number | (mΩ) | (mΩ) | M | N | value | (μm) | Dv50 | (m²/g) | layer (nm) | fades to 80% | cycles | capacity) | mΩ) |
| Embodiment | 42.5 | 56.7 | 0.85 | 10% | 0.62 | 5.3 | 0.5 | 1.73 | 51 | 410 | 6.9% | 88.7% | 63 |
| 1 | | | | | | | | | | | | | |
| Embodiment | 23.4 | 28.5 | 0.82 | 10% | 0.62 | 5.3 | 0.5 | 2.35 | 78 | 462 | 6.2% | 91.8% | 57 |
| 2 | | | | | | | | | | | | | |
| Embodiment | 15.0 | 17.6 | 0.75 | 10% | 0.62 | 5.3 | 0.5 | 2.93 | 125 | 496 | 6.3% | 93.1% | 56 |
| 3 | | | | | | | | | | | | | |
| Embodiment | 36.4 | 43.9 | 0.83 | 10% | 0.62 | 5.3 | 0.5 | 2.41 | 76 | 421 | 6.6% | 81.9% | 60 |
| 4 | | | | | | | | | | | | | |
| Embodiment | 32.5 | 50 | 0.65 | 10% | 0.62 | 5.3 | 0.5 | 2.67 | 36 | 342 | 6.8% | 89.2% | 67 |
| 5 | | | | | | | | | | | | | |
| Embodiment | 28.4 | 35.9 | 0.79 | 10% | 0.62 | 5.2 | 0.5 | 2.48 | 65 | 376 | 6.5% | 90.4% | 65 |
| 6 | | | | | | | | | | | | | |
| Embodiment | 35.2 | 40 | 0.88 | 10% | 0.62 | 5.4 | 0.5 | 2.17 | 130 | 470 | 5.9% | 88.0% | 71 |
| 7 | | | | | | | | | | | | | |
| Embodiment | 10.2 | 11.1 | 0.92 | 5% | 0.62 | 5.3 | 0.5 | 2.39 | 77 | 752 | 4.7% | 87.5% | 52 |
| 8 | | | | | | | | | | | | | |
| Embodiment | 164.5 | 228.5 | 0.72 | 20% | 0.62 | 5.5 | 0.5 | 2.43 | 80 | 303 | 8.6% | 93.4% | 78 |
| 9 | | | | | | | | | | | | | |
| Embodiment | 401.4 | 757.4 | 0.53 | 40% | 0.62 | 5.4 | 0.5 | 2.37 | 79 | 176 | 15.8% | 89.1% | 85 |
| 10 | | | | | | | | | | | | | |
| Embodiment | 13.2 | 16.5 | 0.80 | 10% | — | 8.5 | — | 4.52 | 76 | 354 | 12.3% | 87.3% | 54 |
| 11 | | | | | | | | | | | | | |
| Embodiment | 8.4 | 11.8 | 0.71 | 10% | — | 8.7 | — | 5.38 | 128 | 390 | 12.0% | 89.4% | 52 |
| 12 | | | | | | | | | | | | | |
| Embodiment | 20.5 | 25.3 | 0.81 | 10% | 0.62 | 5.4 | 0.5 | 2.36 | 81 | 466 | 6.0% | 92.0% | 55 |
| 13 | | | | | | | | | | | | | |
| Embodiment | 28.5 | 34.8 | 0.82 | 10% | 0.62 | 5.5 | 0.5 | 2.40 | 80 | 415 | 5.8% | 90.5% | 60 |
| 14 | | | | | | | | | | | | | |
| Embodiment | 22.0 | 26.2 | 0.84 | 10% | 0.62 | 5.5 | 0.5 | 2.37 | 78 | 472 | 6.2% | 91.6% | 56 |
| 15 | | | | | | | | | | | | | |
| Embodiment | 24.5 | 30.2 | 0.81 | 10% | 0.42 | 5.2 | 0.5 | 2.30 | 75 | 490 | 5.8% | 93.4% | 53 |
| 16 | | | | | | | | | | | | | |
| Embodiment | 24.2 | 29.5 | 0.82 | 10% | 1 | 5.4 | 0.5 | 2.32 | 74 | 445 | 6.5% | 90.8% | 60 |
| 17 | | | | | | | | | | | | | |
| Embodiment | 23.8 | 29.8 | 0.80 | 10% | 0.62 | 5.4 | 0.3 | 2.89 | 76 | 435 | 6.4% | 92.3% | 54 |
| 18 | | | | | | | | | | | | | |
| Embodiment | 24.0 | 28.9 | 0.83 | 10% | 0.62 | 5.3 | 0.6 | 2.01 | 77 | 489 | 6.3% | 90.7% | 60 |
| 19 | | | | | | | | | | | | | |
| Comparative | 35.1 | 68.8 | 0.51 | 10% | 0.62 | 5.5 | 0.5 | — | 80 | 415 | 7.6% | 88.2% | 62 |
| Embodiment | | | | | | | | | | | | | |
| 1 | | | | | | | | | | | | | |
| Comparative | 39.5 | 43.9 | 0.90 | 0 | 0.62 | 5.4 | 0.5 | 1.36 | — | 350 | 6.5% | 83.2% | 63 |
| Embodiment | | | | | | | | | | | | | |
| 2 | | | | | | | | | | | | | |
| Comparative | 20.4 | 52.3 | 0.39 | 10% | 0.62 | 5.5 | 0.5 | 3.87 | 210 | 321 | 7.0% | 85.2% | 69 |
| Embodiment | | | | | | | | | | | | | |
| 3 | | | | | | | | | | | | | |
| Comparative | 23.7 | 28.2 | 0.84 | 10% | 2.4 | 5.3 | 0.5 | 2.35 | 80 | 387 | 8.2% | 88.5% | 65 |
| Embodiment | | | | | | | | | | | | | |
| 4 | | | | | | | | | | | | | |
| Comparative | 21.4 | 34.0 | 0.63 | 10% | 0.62 | 5.4 | 0.05 | 3.69 | 82 | 353 | 6.8% | 92.8% | 51 |
| Embodiment | | | | | | | | | | | | | |
| 5 | | | | | | | | | | | | | |
| Comparative | 24.8 | 33.1 | 0.75 | 10% | 0.62 | 5.5 | 0.8 | 1.78 | 75 | 378 | 6.9% | 89.5% | 72 |
| Embodiment | | | | | | | | | | | | | |
| 6 | | | | | | | | | | | | | |

As can be learned from the test results of Embodiments 1˜19 and Comparative Embodiments 1˜6, in contrast with the lithium-ion battery prepared by using the negative electrode that does not satisfy M≥0.5 and N=2 wt %˜80 wt %, the lithium-ion battery prepared by using the negative electrode that satisfies M≥0.5 and N=2 wt %˜80 wt % achieves higher cycle performance, higher rate performance, a higher strain-resistant capability, and a lower direct-current resistance.

As can be learned from the test results of Embodiment 2, Embodiments 16˜19, and Comparative Embodiments 4˜6, the change of the I2/I1 ratio value has little effect on the value of M. However, a lower I2/I1 ratio value can improve the cycle performance, the rate performance, and reduce the expansion rate of the battery. Further, as can be learned from the test results, when Dn10/Dv50<0.3, small silicon particles increase and are difficult to disperse, and M decreases, thereby improving the rate performance but bringing an adverse effect on the cycle performance and the expansion rate of the battery; and, when Dn10/Dv50>0.6, the large silicon particles increase, the rate performance and the cycle performance of the battery are lower, and the expansion rate is higher.

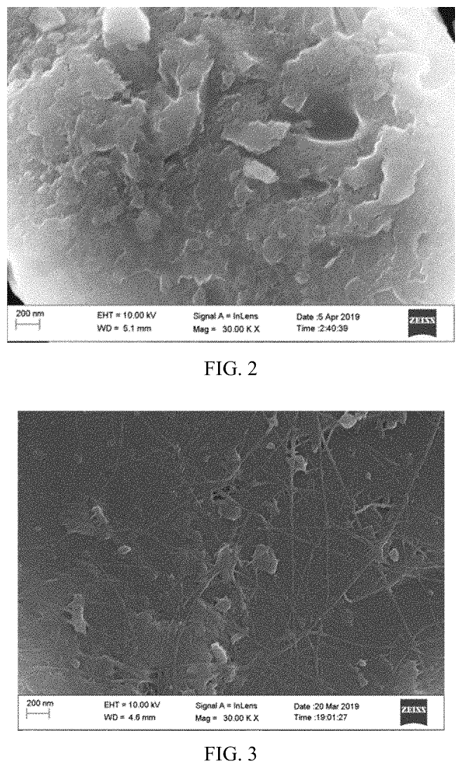

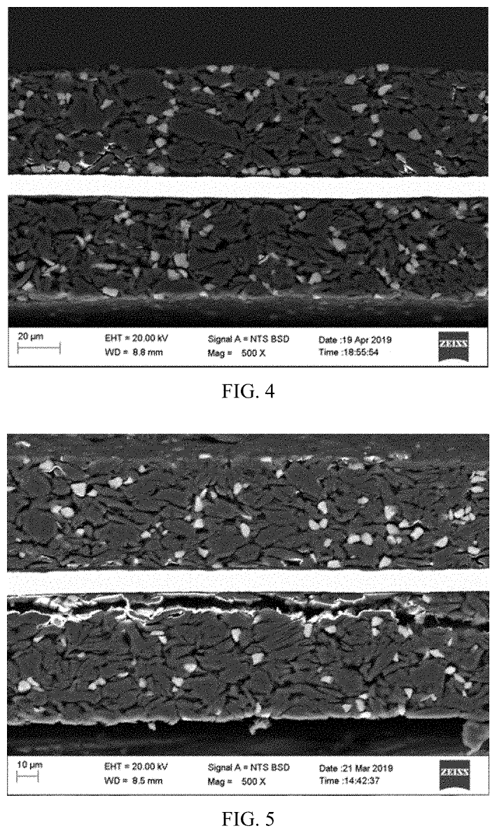

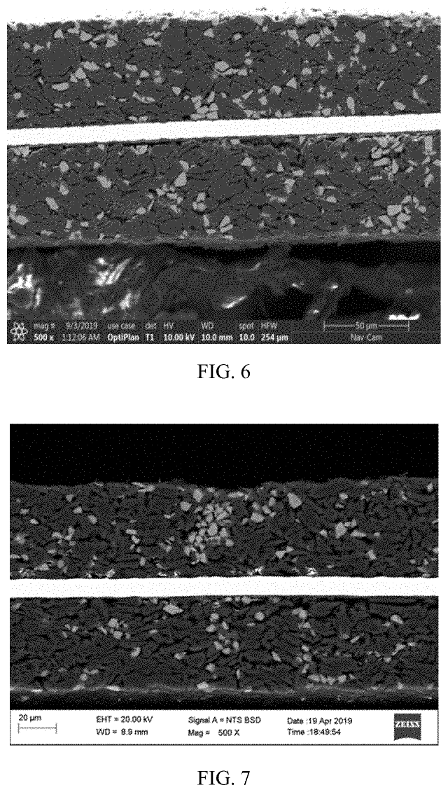

FIG. 2 shows a scanning electron microscope (SEM) image of the surface of SiO particles; and FIG. 3 shows an SEM image of the surface of the silicon-based negative active material according to Embodiment 2 of this application. As can be seen from FIG. 3, the CNTs and the polymer are homogeneously distributed on the surface of the silicon-based particles. FIG. 4 shows an SEM image of a cross section of a negative electrode according to Embodiment 2 of this application. As can be seen from FIG. 4, the silicon-based particles are homogeneously dispersed in the graphite. FIG. 5 shows an SEM image of a cross section of a negative electrode according to Embodiment 8 of this application. As can be seen from FIG. 5, when there are fewer silicon-based particles, the particles are dispersed in the graphite more homogeneously. FIG. 6 shows an SEM image of a cross section of a negative electrode according to Embodiment 9 of this application. Compared with Embodiment 9, the silicon-based particles in Embodiment 2 and Embodiment 8 are dispersed in the graphite more homogeneously. FIG. 7 shows an SEM image of a cross section of a negative electrode according to Comparative Embodiment 1 of this application. As can be seen from FIG. 7, the silicon-based particles in Comparative Embodiment 1 are agglomerated together massively. That is because, in Comparative Embodiment 1, CNTs and SiO are directly mixed with the graphite, and the CNTs are likely to entangle SiO together, thereby causing agglomeration of SiO.

References to “embodiments”, “some embodiments”, “an embodiment”, “another example”, “example”, “specific example” or “some examples” throughout the specification mean that at least one embodiment or example in this application includes specific features, structures, materials, or characteristics described in the embodiment(s) or example(s). Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment or example in this application. In addition, specific features, structures, materials, or characteristics herein may be combined in one or more embodiments or examples in any appropriate manner.

Although illustrative embodiments have been demonstrated and described above, a person skilled in the art understands that the above embodiments shall not be construed as a limitation on this application, and changes, replacements, and modifications may be made to the embodiments without departing from the spirit, principles, and scope of this application.

What is claimed is:

1. A negative electrode, comprising: a current collector and a coating located on the current collector, wherein the coating comprises silicon-based particles and graphite particles, and a minimum value of film resistances at different positions on a surface of the coating is R1, a maximum value of the film resistances is R2, an R1/R2 ratio is M, and a percentage of a weight of the silicon-based particles in a total weight of the silicon-based particles and the graphite particles is N, wherein M≥approximately 0.5, and N is approximately 2 wt %-80 wt %.

2. The negative electrode according to claim 1, wherein the silicon-based particles comprise a silicon-containing substrate and a polymer layer, the polymer layer comprises a polymer and carbon nanotubes, the polymer layer is located on at least a part of a surface of the silicon-containing substrate.

3. The negative electrode according to claim 1, wherein the silicon-containing substrate comprises SiOₓ, wherein 0.6≤x≤1.5.

4. The negative electrode according to claim 1, wherein the silicon-containing substrate comprises Si, SiO, SiO₂, SiC, a silicon alloy, or any combination thereof.

5. The negative electrode according to claim 1, wherein a grain particle size of Si is less than approximately 100 nm.

6. The negative electrode according to claim 1, wherein, in an X-ray diffraction pattern of the silicon-based particles, a highest intensity value of 2θ attributed to a range of approximately 28.0°-29.0° is I2, and a highest intensity value attributed to a range of approximately 20.5°-21.5° is I1, and approximately 0<I2/I1≤approximately 1.

7. The negative electrode according to claim 1, wherein a particle size distribution of the silicon-based particles satisfies: approximately 0.3≤Dn10/Dv50≤approximately 0.6.

8. The negative electrode according to claim 2, wherein, based on the total weight of the silicon-based particles, a content of the polymer layer is approximately 0.05-15 wt %.

9. The negative electrode according to claim 2, wherein, based on the total weight of the silicon-based particles, a weight ratio of the polymer to the carbon nanotubes in the polymer layer is approximately: 0.5:1-10:1.

10. The negative electrode according to claim 2, wherein the polymer comprises carboxymethyl cellulose, polyacrylic acid, polyvinylpyrrolidone, polyaniline, polyimide, polyamideimide, polysiloxane, polystyrene butadiene rubber, epoxy resin, polyester resin, polyurethane resin, polyfluorene, or any combination thereof.

11. The negative electrode according to claim 2, wherein a thickness of the polymer layer is approximately 5-200 nm.

12. The negative electrode according to claim 1, wherein an average particle size of the silicon-based particles is approximately 500 nm-30 μm.

13. The negative electrode according to claim 1, wherein a specific surface area of the silicon-based particles is approximately 1-50 m²/g.

14. The negative electrode according to claim 2, wherein, based on the total weight of the silicon-based particles, a content of the carbon nanotubes is approximately 0.01-10 wt %.

15. An electrochemical device, comprising: a negative electrode, wherein the negative electrode comprises a current collector and a coating located on the current collector, wherein the coating comprises silicon-based particles and graphite particles, and a minimum value of film resistances at different positions on a surface of the coating is R1, a maximum value of the film resistances is R2, an R1/R2 ratio is M, and a percentage of a weight of the silicon-based particles in a total weight of the silicon-based particles and the graphite particles is N, wherein M≥approximately 0.5, and N is approximately 2 wt %-80 wt %.

16. The electrochemical device according to claim 15, wherein the silicon-based particles comprise a silicon-containing substrate and a polymer layer, the polymer layer comprises a polymer and carbon nanotubes, the polymer layer is located on at least a part of a surface of the silicon-containing substrate.

17. An electronic device, comprising the electrochemical device according to claim 15.
